(19) United States
(12) Patent Application Publication
(10) Pub. No.: US 2005/0030889 A1
(43) Pub. Date: Feb. 10, 2005

(54) Method and system for transmiting in-band call processing-related traffic using bearer facilities

(75) Inventor: Xin Tao, Naperville, IL (US)

Correspondence Address: Richard J. Minnich;Fay, Sharpe, Fagan, Minnich & McKee, LLP, Seventh Floor, 1100 Superior Avenue, Cleveland, OH, 44114, US

(73) Assignee: Lucent Technologies Inc.

(21) Appl. No.: 10/633,786

(22) Filed: Aug. 4, 2003

(51) Int. Cl. H04L 12/26

(52) U.S. Cl. 370/229

(57) ABSTRACT

A method for transmitting call processing-related traffic in a voice over packet network having a plurality of bearer links. The method includes creating at least one logical tunnel in each of the bearer links, establishing a priority for the call processing-related traffic, and transmitting the call processing-related traffic through the logical tunnels in the bearer links.

### FIELD OF THE INVENTION

The present invention relates to the field of telecommunications in general, and more particularly, to a method and system for transmitting in-band call processing-related traffic using bearer facilities in distributed voice over packet systems.

### BACKGROUND OF THE INVENTION

The traditional telephone network, known as the Public Switched Telephone Network (PSTN), contains a network of switches for connecting telephones worldwide. In the PSTN, all phone calls are circuit-switched. That is, for every call, a dedicated line is assigned from the calling party's handset all the way to the called party's handset, and this line remains fixed for the duration of the call. However, in a packet-switched network, small units of data (or packets) are routed through the network based upon the destination address for each packet. This type of communication is essentially connectionless, not dedicated like the circuit-switched network. Once the data is sent, the connection is broken until further information is either sent or received. This allows the packet-switched network to be shared by a larger number of users.

There are various types of packet networks, including wide area networks (WANs), local area networks (LANs), and the Internet. These packet networks employ a number of transmission protocols and physical layers, such as Internet Protocol (IP), Asynchronous Transfer Mode (ATM), and Frame Relay (FR). Voice and data (bearer) traffic is increasingly being transmitted over the various types of packet networks. The generic term, which covers all types of packet networks, is voice over packet (VoP).

In VoP systems, gateways are needed to connect network traffic between circuit-switched and packet-switched networks for service providers. Examples of the various gateways are media gateways and IP gateways. In a geographically distributed VoP system, a single media gateway controller can control many media gateways. In such a system, the media gateways can be located far away from the media gateway controller. A high capacity and reliable network connecting all media gateways together for bearer traffic is necessary. Typically, call processing-related traffic, such as call control (messages or instructions used to create and tear down the end-to-end bearer path) and OAM&P (operations, administration, maintenance and provisioning messages or instructions), and bearer traffic are transmitted over separate networks. However, it is costly to maintain separate networks for all of the traffic over the VoP system. Therefore, there is a need for a cost effective way to transmit call processing-related traffic as well as bearer traffic in distributed voice over packet systems.

### SUMMARY OF THE INVENTION

In accordance with one aspect of the invention, a method for transmitting call processing-related traffic in a voice over packet network having a plurality of bearer links is provided. The method includes creating at least one logical tunnel in one of the bearer links that are all terminated on the same media gateway, establishing a priority for the call processing-related traffic, and transmitting the call processing-related traffic through the logical tunnels in the bearer links.

In accordance with another aspect of the invention, a system for transmitting call processing-related traffic in a voice over packet network having a plurality of bearer links is provided. The system includes means for creating at least one logical tunnel in one of the bearer links that are all terminated on the same media gateway, means for establishing a priority for the call processing-related traffic, and means for transmitting the call processing-related traffic through the logical tunnels in the bearer links.

Still further advantages and benefits of the present invention will become apparent to those of ordinary skill in the art upon reading and understanding the following detailed description of the preferred embodiments.

### BRIEF DESCRIPTION OF THE DRAWINGS

The drawings are only for purposes of illustrating preferred embodiments and are not to be construed as limiting the invention. The invention may take form in various components and arrangements of components, and in various steps and arrangements of steps, the preferred embodiments of which will be illustrated in the accompanying drawings wherein:

FIG. 1 is a block diagram illustrating a voice over packet system;

FIG. 2 is a block diagram illustrating an exemplary embodiment of a voice over packet system according to the present invention; and

FIG. 3 is a flow chart illustrating a method of transmitting call processing-related traffic in a voice over packet system according to the present invention.

### DETAILED DESCRIPTION OF THE INVENTION

It is understood that the specific devices and methods illustrated in the attached drawings and described in the following specification are simply exemplary embodiments of the inventive concepts defined in the appended claims. Therefore, specific examples and characteristics related to the embodiments disclosed herein are not to be considered as limiting, unless the claims expressly state otherwise.

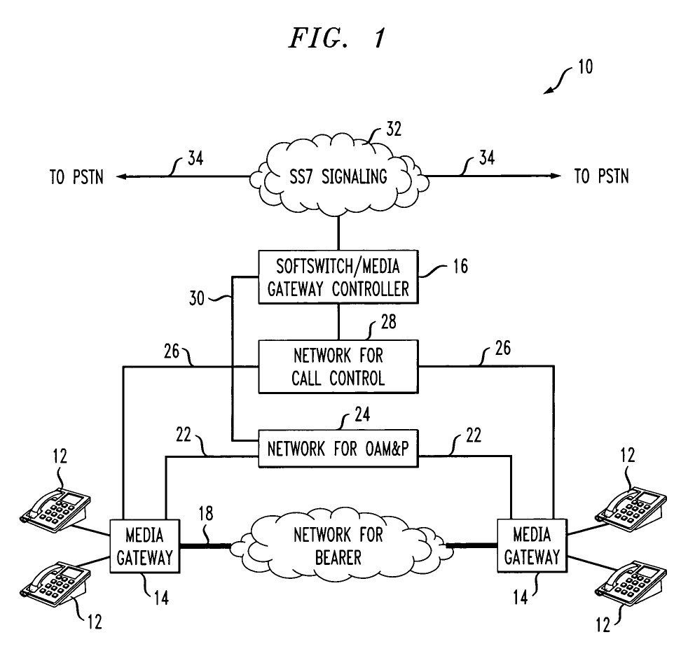

FIG. 1 illustrates an example of a voice over packet (VoP) system 10. The VoP system 10 may be any type of VoP system known in the art, such as VoIP (Internet Protocol) and VoATM (Asynchronous Transfer Mode). VoIP refers generally to a set of facilities for managing the delivery of voice and data using the Internet Protocol (IP). In general, this means sending voice information and data in digital form in discrete packets rather than in the traditional circuit-switched protocols of the public switched telephone network (PSTN). Asynchronous Transfer Mode, or ATM, is a multiservice, high speed, scalable technology. It is a dominant switching structure in carrier networks, supporting services with different transfer characteristics. ATM simultaneously transports voice, data, graphics and video at very high speeds. Large enterprises may connect headquarters and main offices to the wide area network (WAN) via broadband links such as ATM to accommodate their vast amounts of voice and data transmissions, such as heavy graphics, payroll information and voice and video conferencing. Voice telephony over asynchronous transfer mode (VoATM) is a single integrated infrastructure, able to manage and deliver all subscriber signals (audio, data, voice, and video) and switched and dedicated services reliably and efficiently.

The VoP system 10 includes any number of communication devices, such as computers or telephones 12, for placing and receiving calls. The calls are routed through any number of gateways, such as media gateways 14. Media gateways are typically employed to terminate different media (e.g., TDM, IP or ATM) carrying data, manipulate the content of the data (e.g., cancel echo, compress data, suppress silence), switch data from one channel to another channel to provide the connection for a specific session (a call or data link). Media gateways are controlled by a media gateway controller 16 using media gateway control protocol (H.248, MGCP, etc.) for setting up voice calls. Each media gateway 14 can only be controlled by one media gateway controller 16. A media gateway has a set of resources for processing calls and manipulating bearer (voice or user data) traffic.

Bearer traffic (voice or user data) is transmitted between the media gateways 14 via a set of physical bearer links 18 connected by a bearer network 20. The bearer network 20 may include any number of switches (not shown) for connecting calls. Generally, a switch is a device that channels incoming data from any of multiple input ports to the specific output port that will take the data toward its intended destination. For example, in a distributed VoP network such as VoIP a switch determines from the IP address in each packet the output port to use for the next part of its trip to the intended destination. OAM&P (operations, administration, maintenance, and provisioning) is transmitted between the media gateways 14 via a set of physical OAM&P links 22 connected by an OAM&P network 24. There is also a link 30 between the media gateway controller 16 and the OAM&P network 24. Call control is transmitted between the media gateways 14 via a set of physical call control links 26 connected by a call control network 28. Thus, for security and quality of service (QoS) reasons, bearer, call control and OAM&P are typically transmitted over separate networks. Further, a standard SS7 signaling network 32 provides the necessary call signaling via links 34.

However, it is costly to develop and maintain separate, distributed networks for call control, OAM&P, and bearer traffic. Thus, to save costs and yet maintain high quality of service (QoS), it is possible to share a single physical network connecting the media gateways 14 for bearer with call control and OAM&P.

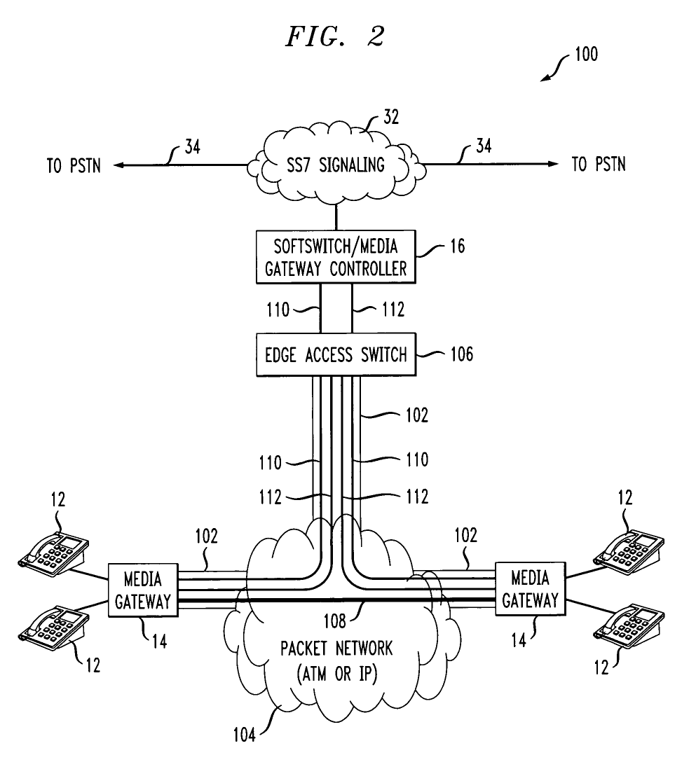

Referring now to FIG. 2, wherein like numerals represent like elements, an improved VoP system 100 is shown. The VoP system 100 may be VoIP, VoATM, or any other telephony packet system known in the art. The VoP system 100 includes any number of computers or telephones 12 for placing and receiving calls. The calls are routed through any number of media gateways 14. The media gateways 14 are controlled by the media gateway controller 16 using media gateway control protocol for setting up voice calls.

The bearer traffic is transmitted between the media gateways 14 via a single set of physical links 102 connected by a packet network 104. It is to be understood, however, that there may be additional sets of physical links in the systems depending upon the application. The packet network 104 may include any number of switches and routers (not shown) for connecting calls. In the system 100, all of the necessary call processing-related traffic, i.e., the call control and the OAM&P, as well as the bearer traffic are distributed over the single set of physical links 102. A set of logical bearer links 108, a set of logical call control links 110, and a set of logical OAM&P links 112 are connected to the physical link 102 via an edge access switch 106. A standard SS7 signaling network 32 provides the necessary call signaling via links 34.

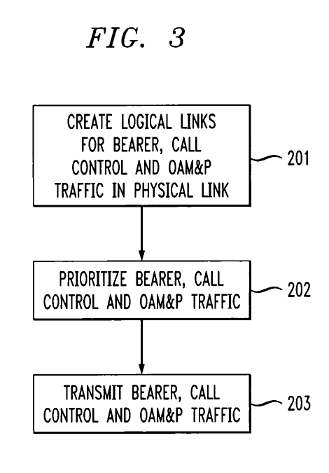

A method for establishing the VoP system 100 of FIG. 2 is illustrated in FIG. 3. This method may implemented through computer software in the media gateways 14. The first step 201 is to create three sets of separated logical links (also known as tunnels) 108, 110, and 112 within the physical links 102 for bearer, call control, and OAM&P, respectively. It is to be understood, however, that there may be additional logical links within the physical links 102, depending upon the needs of the system 100. Such logical tunnels may be created by any known means in the art, including ATM PVC (Permanent Virtual Circuit), ATM SVC (Switched Virtual Circuit), and VPN (Virtual Private Network).

In VoATM systems, the logical tunnels 108, 110, and 112 may be separated using methods well known in the art, such as different switched virtual circuits (SVCs) or permanent virtual circuits (PVCs) with different service profiles. In a PVC, preselected paths from switch to switch are set up ahead of time. On the other hand, in an SVC, the packets travel along paths that are continuously being set up and torn down again after a designated period. Thus, SVCs occupy switching capacity only while they are set up, increasing switch efficiency.

In IP networks, the logical tunnels 108, 110, and 112 may be separated using different virtual private networks (VPN) with different multiprotocol label switching (MPLS) tags. VPN network tunneling generally involves establishing and maintaining a logical network connection. On this connection, packets constructed in a specific VPN protocol format are encapsulated within some other base or carrier protocol, transmitted between VPN client and server, and then de-encapsulated on the receiving side. VPN tunneling protocols include Point-to-Point Tunneling Protocol (PPTP), Layer Two Tunneling Protocol (L2TP), and Internet Protocol Security (IPsec). MPLS generally transforms IP-based traffic into circuit-switched traffic at the network edge. This is accomplished by labeling packets to be transported across the network. Labels tell each ATM switch how to process and forward packets. As packets traverse the network, label swaps are performed at each node, preferably by using a label-forwarding database.

Thus, the logical channels provide dedicated logical links through the packet network shared by all types of traffic. The types of traffic are logically separated. It is expected that there will be no traffic crossing from one channel to another channel.

The next step 202 is to prioritize the traffic (or packets). This is accomplished because different traffic typically needs to be treated differently. For example, the bearer traffic for voice should have low latency and should be treated such that the delay is minimized. Voice stream is continuous. Delayed voice packet is nearly useless, but still uses network bandwidth. Therefore, if a packet for voice bearer is delayed beyond a predefined time interval, the packet should be dropped. On the other hand, OAM&P traffic is more tolerant to delay but not packet loss. Otherwise, the packet would have to be re-transmitted through the network causing more network congestion. Therefore, OAM&P traffic should be treated in such a way that the packet can be delayed, but not thrown out. Of course, if the set of physical links 102 carrying all of the logical tunnels 108, 110, and 112 is congested, some packets will be dropped according to the service characteristics. The packets may be prioritized by any known means in the art, including using different ATM service profiles for specific PVCs and SVCs or different DiffServ markings. Additionally, different MPLS tags for different types of traffic may be used. By specifying different service profiles, different traffic will have different priority and be treated differently according to the characteristics of the type of traffic.

The next step 203 is to transmit the traffic—bearer, call control, and OAM&P—through the logical tunnels 108, 110, and 112, respectively, in the physical links 102. The call control links 110 and the OAM&P links 112 are connected to the physical links 102 via an edge access switch 104, which acts as the gateway to send the OAM&P and call control traffics to the dedicated channels and receive the traffics from those channels for different applications. The same or similar functions are accomplished at the media gateway, which acts as an access gateway and sends different traffic to different logical channels.

Thus, all of the traffic—bearer, call control, and OAM&P—share the core packet network 104 and the physical links 102 with different logical (virtual) paths. The virtual paths for call control and OAM&P may be end-to-end (from the media gateway controller 16 to the media gateways 14). Thus, preselected virtual paths may be provisioned as part of the system configuration.

The idea of sharing the call control and OAM&P traffic with bearer traffic is introduced to reduce the cost of setting up and maintaining physically separated networks. Thus, cost is reduced, while security and QoS as required for the service are preserved.

The invention has been described as a reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A method for transmitting call processing-related traffic in a voice over packet network having at least one set of physical links for bearer traffic, comprising:
creating a plurality of logical tunnels in said physical links for said call processing-related traffic and said bearer traffic;
establishing priorities for said call processing-related traffic and said bearer traffic; and
transmitting said call processing-related traffic and said bearer traffic through said logical tunnels in said physical links.

2. The method defined in claim 1, wherein said call processing-related traffic includes call control and OAM&P.

3. The method defined in claim 1, wherein said voice over packet network comprises an ATM network.

4. The method defined in claim 3, further comprising separating said logical tunnels by using different switched virtual circuits with different service profiles.

5. The method defined in claim 4, wherein said call processing-related traffic includes call control and OAM&P.

6. The method defined in claim 3, further comprising separating said logical tunnels by using different permanent virtual circuits with different service profiles.

7. The method defined in claim 6, wherein said call processing-related traffic includes call control and OAM&P.

8. The method defined in claim 1, wherein said voice over packet network comprises an IP network.

9. The method defined in claim 8, further comprising separating said logical tunnels by using different virtual private networks with different multiprotocol label switching tags.

10. The method defined in claim 9, wherein said call processing-related traffic includes call control and OAM&P.

11. A system for transmitting call processing-related traffic in a voice over packet network having at least one set of physical links for bearer traffic, comprising:
means for creating a plurality of logical tunnels in said physical links;
means for establishing priorities for said call processing-related traffic and said bearer traffic; and
means for transmitting said call processing-related traffic and said bearer traffic through said logical tunnels in said physical links.

12. The system defined in claim 11, wherein said call processing-related traffic includes call control and OAM&P.

13. The system defined in claim 11, wherein said voice over packet network comprises an ATM network.

14. The system defined in claim 13, further comprising means for separating said logical tunnels by using different switched virtual circuits with different service profiles.

15. The system defined in claim 14, wherein said call processing-related traffic includes call control and OAM&P.

16. The system defined in claim 13, further comprising separating said logical tunnels by using different permanent virtual circuits with different service profiles.

17. The system defined in claim 16, wherein said call processing-related traffic includes call control and OAM&P.

18. The system defined in claim 11, wherein said voice over packet network comprises an IP network.

19. The system defined in claim 18, further comprising separating said logical tunnels by using different virtual private networks with different multiprotocol label switching tags.

20. The system defined in claim 19, wherein said call processing-related traffic includes call control and OAM&P.
